(19) United States
(12) Patent Application Publication
(10) Pub. No.: US 2026/0239022 A1
(43) Pub. Date: Aug. 13, 2026

(54) Reduced Radio Transmitter Power Use and Method Therefor

(71) Applicant: HALTER USA INC., San Francisco, CA (US)

(72) Inventors: Sindre FRISVOLD, Auckland (NZ); Namyoon KIM, Auckland (NZ)

(73) Assignee: HALTER USA INC., San Francisco, CA (US)

(21) Appl. No.: 19/474,713

(22) PCT Filed: Apr. 28, 2024
(86) PCT No.: PCT/IB2024/053406

§ 371 Date: Oct. 12, 2025

(30) Foreign Application Priority Data
Apr. 11, 2023 (AU) 2023901058

(51) Int. Cl. H04W 16/18; H02J 50/00; H04W 4/021; H04W 24/10; H04W 52/02

(52) U.S. Cl. CPC H04W 16/18; H04W 4/021; H04W 24/10; H04W 52/0206; H04W 52/0209; H02J 50/001

(57) ABSTRACT

A system and method for managing wireless communication over an area using solar-powered radio transceivers. A processor selects an optimal transceiver to communicate with nodes in the area based on historical link quality strength of previous nodes in the same area. Different power reduction techniques are employed for non-selected transceivers, including turning them off or reducing power consumption.

### CROSS-REFERENCE TO RELATED APPLICATIONS

This application is a U.S. National Stage of International Patent Application No. PCT/IB2024/053406, filed on Apr. 8, 2024, pending, and claims priority to Australian Patent Application No. 2023901058, filed on Apr. 11, 2023, both of which are incorporated herein by reference in their entireties.

### TECHNICAL FIELD

The present invention relates to an apparatus and method to reduce power to, or use by, one or more of multiple radio transceivers configured to one or more end nodes. More particularly but not exclusively, it relates to a method of measuring the signal strength from multiple moveable nodes by multiple radio transceivers and forming a historical heat map of signal strength to thereby make radio transceiver selection choices at a later time.

### BACKGROUND OF THE INVENTION

In the field of wireless communications, the use of radio transceivers to establish connectivity between nodes has become increasingly ubiquitous. Where a large area of radio coverage is required, there may be multiple radio transceivers used. Naturally, there is typically some overlap between the coverage. In some scenarios multiple radio transceivers may communicate with the same node. Nodes may be a sensor or electronic device of any description that is able to communicate with the transceiver. One of the concerns with using radio transceivers is the power consumption required by radio transceivers to maintain communication to and from a node. While the use of low-power, energy-efficient transceivers has helped to mitigate this issue, there remains a need for further optimization of power usage to extend battery life and reduce the overall energy footprint of wireless communication systems. In prior art, there have been various attempts to reduce power usage by radio transceivers configured to communicate with end nodes. One approach involves reducing the transmission power of the radio transceivers, but this has the disadvantage of potentially reducing the range of the communication.

### Object of the Invention

It is an object of the present invention to provide a radio transceiver, and or controller of, and method therefor that overcomes or at least partially ameliorates some of the abovementioned disadvantages or which at least provides the public with a useful choice.

### SUMMARY OF THE INVENTION

In one aspect the invention resides in a method of operating a processor to remotely control the power use of two or more fixed location radio transceivers dependent on the location of one or more movable nodes, the method comprising,
populating a historical geo-spatial database comprising the steps of receiving, with each transceiver, a set of uplinks comprising location data over time from the one or more nodes, and for each received uplink, mapping a geoindex of the database comprising the transceiver and a measured link quality based on the node location; then
receiving, with one or more transceivers, an uplink from a node;
determining the geoindex of the received uplink from the database; and
reducing power to, or consumption of power by, at least one transceiver based on the determined geo-index and one or more predefined selection criteria.

In another aspect the invention resides in a system for controlling power usage of radio devices comprising:
one or more moveable nodes comprising a sensor configured to return location data and a transmitter to transmit the location data by uplinks;
two or more fixed location radio transceivers comprising two or more power consumption modes and each configured to receive the uplinks from the one or more nodes and output transceiver data comprising link quality data for each received uplink and node location data;
a processor configured to:
   receive transceiver data,
   populate a geo-spatial database with the received transceiver data including geo-indices of transceiver data based on the node location data, and
   control the power consumption mode of at least one radio transceiver based on received node location data, a determined geo-index, and one or more predefined selection criteria.

In another aspect the invention resides in a system for controlling power usage of radio devices comprising:
one or more moveable nodes, each node comprising:
   a sensor configured to determine location data, and
   a transmitter configured to transmit location data by radio uplinks;
two or more fixed location radio transceiver devices, each device comprising a radio component configured to receive uplinks and output transceiver data comprising link quality data and node location data; and
a processor configured to:
   receive transceiver data,
   populate a geo-spatial database with received transceiver data including geo-indices of transceiver data based on the node location data, and
   control one of two or more power consumption modes of one or more radio transceiver devices based on:
      node location data,
      a determined geo-index, and
      one or more predefined selection criteria.

In one embodiment, the link quality data is defined by analysing or determining one or more selected from
number of packets received or lost during uplink;
signal-to-noise ratio (SNR) of the uplink;
bit error rate (BER) of the uplink;
received signal strength indicator (RSSI) of the uplink;
delay or latency of the uplink;
carrier-to-noise ratio (CNR) of the uplink;
modulation and coding scheme (MCS) used for the transmission of the uplink;
presence of interference of the uplink from other nearby wireless devices or sources;
received signal strength (RSS) of the uplink; and
reference signal received power (RSRP) of the uplink.

In one embodiment, the predefined selection criteria comprises one or more of the following:
the retrieved associated transceivers with associated geo-indices with the most nodes, or the fewest transceivers which comprise the most or all nodes;
a highest battery level of the transceiver, or a highest average battery level of a group of transceivers; and
the highest RSS, or best link quality, transceiver for a geo-index; the highest average RSS, or best average link quality, over multiple geo-indices; or the highest average RSS, or best average link quality, over a group of transceivers.

In one embodiment, the processor is configured for creating a set for an associated transceiver and the associated nodes the transceiver receives an uplink from.

In one embodiment, the processor is configured for grouping together transceiver sets, so a majority of nodes are assigned at least one transceiver within a group.

In one embodiment, the processor is configured for grouping together transceiver sets, so all nodes are assigned at least one transceiver within a group.

In one embodiment, the processor is configured for grouping together transceiver sets, where each group is a different combination of transceivers.

In one embodiment, the predefined selection criteria comprises one or more of the following: the most or all nodes of the associated geo-indices, or the group with the fewest transceivers which comprises all nodes,
a highest battery level of the transceiver, or a highest average battery level of a group of transceivers, and
the highest RSS for a geo-indicies, or the highest average RSS over multiple geo-indices, or the highest average RSS over a group of transceivers.

In one embodiment, the processor is configured for determining a ranking of at least two transceivers based on the selection criteria, and where: the highest average, highest minimum, or highest RSS data is within a predefined threshold, and the lower ranked of the ranked transceivers has higher available battery level, selecting the lower ranked transceiver.

In one embodiment, the predefined selection criteria comprises one of:
the highest average RSS, where the average RSS is across all geo-indices which contain nodes, the highest minimum RSS across all geo-indices which contain nodes, above a threshold RSS, above a threshold RSS across all geo-indices which contain nodes, and
the highest RSS from a transceiver per geo-index which contains nodes and the processor selects a transceiver for each geo-index.

In one embodiment, the processor is configured for reducing power to, or consumption by, the non-selected transceiver(s) comprises one of more of:
leaving off the transceiver(s),
turning off the transceiver(s),
reducing power to the transceiver(s),
reducing power to the transceiver(s) to zero,
turning off power supply to the transceiver(s), and
turning off packet forwarding on the transceiver(s).

In one embodiment, the transceiver is one of LPWAN, NB-IoT, LTE-M, Wi-Fi, MYTHINGS, LoRa, Sigfox, Bluetooth, Z-wave, and a Zigbee transceiver.

In one embodiment, the transceiver is a long-range radio gateway, and/or more preferably a low power long-range radio gateway.

In one embodiment, the gateway is a Kona Macro IoT Gateway.

In one embodiment, the transceiver utilises a LoRaWAN software communication protocol.

In one embodiment, the transceiver is powered by a limited or finite power supply.

In one embodiment, the transceiver is powered by a remote power supply.

In one embodiment, the transceiver is powered by one or more batteries.

In one embodiment, the power supply comprises a solar power supply and batteries.

In one embodiment, the battery level is determined as the state of charge, voltage, and/or available run time.

In one embodiment, a controller is configured to control power from the batteries to the transceiver.

In one embodiment, the processor is configured to control the controller.

In one embodiment, the transceiver is configured to communicate directly or indirectly with the processor.

In one embodiment, the processor is a remote processor.

In one embodiment, one or more geo-indices within a paddock area are assigned a paddock ID by the processor.

In one embodiment, nodes are assigned said paddock IDs when they are located in an associated geo-index within said paddock ID.

In one embodiment, the predefined selection criteria comprises one of:
the transceiver(s) with the highest average RSS based on the average RSS from each transceiver across all geo-indices with the same paddock ID,
the highest minimum RSS from each transceiver(s) across all geo-indices with the same paddock ID, above a threshold RSS.

In one embodiment, the geo-index is a polygon defined by a user.

In one embodiment, the geo-index is a paddock.

In one embodiment, the geo-index is a virtually fenced area configured to constrain cattle.

In one embodiment, multiple transceivers are selected.

In one embodiment, the nodes are smart devices configured to be worn by cattle.

In one embodiment, the smart devices are smart wearable collars.

In one embodiment, the processor is configured for the step of populating the geo-spatial database with the most recent RSS received by said transceivers.

In one embodiment, the processor is configured for the step of continuously updating the geo-spatial database every period of time.

In one embodiment, the period of time is 30 minutes.

In one embodiment, the paddocks are at least physically fenced and/or virtually fenced paddocks.

In one embodiment, there are more than 30, 50, 80, 100, 200, 300, 500, 1000, 2000, 4000, 6000 nodes.

In one embodiment, there are more than 3 transceivers.

In another aspect the invention resides in a method of operating a processor to remotely control the power use of two or more fixed location radio transceivers dependent on the location of one or more movable nodes located in an area, the method comprising,
populating a geo-spatial database with link quality data associated with the one or more nodes (‘historical nodes’) as received by each transceiver over a period of time, by the steps of:
   instructing all transceivers to receive one or more uplinks from the one or more historical nodes, the uplinks comprising at least historical node location data,
   instructing the one or more historical nodes to send periodic uplinks,
   measuring link quality of one or more uplinks,
   associating each node location with a geo-index of the geo-spatial database,
   assigning the link quality data and associated transceiver to said geo-index, and
receiving an uplink from nodes and determining their current location and their associated geo-index, the nodes being the same or different to the historical nodes whose link quality was measured,
identifying associated transceivers with a link quality data above a threshold for each associated geo-index,
selecting one or more of said retrieved associated transceivers based on the according to one or more predefined selection criteria,
reducing power to, or consumption of power by, all other transceivers except the one or more selected transceivers.

The below embodiments may relate to any one or more of the above aspects.

In one embodiment, the link quality data is defined by analysing the number of packets received or lost during communication.

In one embodiment, the link quality is defined by RSS.

In one embodiment, the link quality can be determined by analysing the signal-to-noise ratio (SNR) of the received signal.

In one embodiment, the link quality can be determined by analysing the bit error rate (BER) of the received signal.

In one embodiment, the link quality can be determined by analysing the received signal strength indicator (RSSI) of the received signal.

In one embodiment, link quality is determined by analysing the delay or latency of the received signal.

In one embodiment, the link quality can be determined by analysing the carrier-to-noise ratio (CNR) of the received signal.

In one embodiment, the link quality can be determined by analysing the modulation and coding scheme (MCS) used for the transmission.

In one embodiment, the link quality can be determined by analysing the presence of interference from other nearby wireless devices or sources.

In one embodiment, the link quality can be determined by the Reference Signal Received Power (RSRP).

In one embodiment, the predefined selection criteria comprises one or more of the following:
the retrieved associated transceivers with associated geo-indices with the most nodes, or the fewest transceivers which comprise the most or all nodes,
a highest battery level of the transceiver, or a highest average battery level of a group of transceivers, and
the highest RSS, or best link quality, transceiver for a geo-index; the highest average RSS, or best average link quality, over multiple geo-indices; or the highest average RSS, or best average link quality, over a group of transceivers.

In one embodiment, the geo-spatial index and spatial database is the h3 Hexagonal hierarchical geospatial indexing system.

In one embodiment, the geo-index is resolution 13.

In one embodiment, the method is carried out on a processor.

In one embodiment, the threshold RSS is an RSS where there are low packet error rates between the transceiver and node.

In one embodiment, the threshold link quality is defined as an RSSI greater than −110 decibel-milliwatts (dBm).

In one embodiment, the radio signal strength (RSS) is measured via one or more of; RSSI (Received Signal Strength Indicator), SNR (Signal-to-Noise Ratio), and RSRP (Reference Signal Received Power). In one embodiment, the threshold RSSI is over −115 dBm.

In one embodiment, the threshold RSSI is over −115 dBm and combined with a threshold Signal-to-Noise Ratio over −7 dB.

In one embodiment, the threshold RSSI is over −120 dBm.

In one embodiment, the highest RSSI refers to the strongest RSSI.

In one embodiment, the method comprises creating a set for an associated transceiver and the associated nodes the transceiver receives an uplink from.

In one embodiment, the method comprises grouping together transceiver sets, so a majority of nodes are assigned at least one transceiver within a group.

In one embodiment, the method comprises grouping together transceiver sets, so all nodes are assigned at least one transceiver within a group.

In one embodiment, the method comprises grouping together transceiver sets, where each group is a different combination of transceivers.

In one embodiment, the predefined selection criteria comprises one or more of the following:
the most or all nodes of the associated geo-indices, or the group with the fewest transceivers which comprises all nodes,
a highest battery level of the transceiver, or a highest average battery level of a group of transceivers, and
the highest RSS for a geo-index, or the highest average RSS over multiple geo-indices, or the highest average RSS over a group of transceivers.

In one embodiment, the method further comprises determining a ranking of at least two transceivers based on the selection criteria, and where: the highest average, highest minimum, or highest RSS data is within a predefined threshold, and the lower ranked of the ranked transceivers has higher available battery level, selecting the lower ranked transceiver.

In one embodiment, the predefined selection criteria comprise one of:
the highest average RSS, where the average RSS is across all geo-indices which contain nodes,
the highest minimum RSS across all geo-indices which contain nodes, above a threshold RSS,
above a threshold RSS across all geo-indices which contain nodes, and
the highest RSS from a transceiver per geo-index which contains nodes and the processor selects a transceiver for each geo-index.

In one embodiment, the method comprises reducing power to, or consumption by, the non-selected transceiver(s) comprises one of more of:
leaving off the transceiver(s),
turning off the transceiver(s),
reducing power to the transceiver(s),
reducing power to the transceiver(s) to zero,
turning off power supply to the transceiver(s), and
turning off packet forwarding on the transceiver(s).

In one embodiment, the transceiver is one of LPWAN, NB-IoT, LTE-M, Wi-Fi, MYTHINGS, LoRa, Sigfox, Bluetooth, Z-wave, and a Zigbee transceiver.

In one embodiment, the transceiver is a long-range radio gateway, and/or more preferably a low power long-range radio gateway.

In one embodiment, the gateway is a Kona Macro IoT Gateway.

In one embodiment, the transceiver utilises a LoRaWAN software communication protocol.

In one embodiment, the transceiver is powered by a limited or finite power supply.

In one embodiment, the transceiver is powered by a remote power supply.

In one embodiment, the transceiver is powered by one or more batteries.

In one embodiment, the power supply comprises a solar power supply and batteries.

In one embodiment, the battery level is determined as the state of charge, voltage, and/or available run time.

In one embodiment, a controller is configured to control power from the batteries to the transceiver.

In one embodiment, the processor is configured to control the controller.

In one embodiment, the transceiver is configured to communicate directly or indirectly with the processor.

In one embodiment, the processor is a remote processor.

In one embodiment, one or more geo-indices within a paddock area are assigned a paddock ID by the processor.

In one embodiment, nodes are assigned said paddock IDs when they are located in an associated geo-index within said paddock ID.

In one embodiment, the predefined selection criteria comprises one of:
the transceiver(s) with the highest average RSS based on the average RSS from each transceiver across all geo-indices with the same paddock ID,
the highest minimum RSS from each transceiver(s) across all geo-indices with the same paddock ID, above a threshold RSS.

In one embodiment, the geo-index is a polygon defined by a user.

In one embodiment, the geo-index is a paddock.

In one embodiment, the geo-index is a virtually fenced area configured to constrain cattle.

In one embodiment, multiple transceivers are selected.

In one embodiment, the nodes are smart devices configured to be worn by cattle.

In one embodiment, the smart devices are smart wearable collars.

In one embodiment, the method comprises the step of populating the geo-spatial database with the most recent RSS received by said transceivers.

In one embodiment, the method comprises the step of continuously updating the geo-spatial database every period of time.

In one embodiment, the period of time is 30 minutes.

In one embodiment, the paddocks are at least physically fenced and/or virtually fenced paddocks.

In one embodiment, there are more than 30, 50, 80, 100, 200, 300, 500, 1000, 2000, 4000, 6000 nodes.

In one embodiment, there are more than 3 transceivers.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, a reference to such external documents is not to be construed as an admission that such documents, or such sources of information, in any jurisdiction, are prior art, or form part of the common general knowledge in the art.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary.

It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, the term “and/or” means “and” or “or”, or both.

As used hereinbefore and hereinafter, “(S)” following a noun means the plural and/or singular forms of the noun.

When used in the claims and unless stated otherwise, the word ‘for’ is to be interpreted to mean only ‘suitable for’, and not for example, specifically ‘adapted’or ‘configured’for the purpose that is stated.

For the purpose of this specification, where method steps are described in sequence, the sequence does not necessarily mean that the steps are to be chronologically ordered in that sequence, unless there is no other logical manner of interpreting the sequence.

The entire disclosures of all applications, patents and publications, cited above and below, if any, are hereby incorporated by reference.

### BRIEF DESCRIPTION OF THE DRAWINGS

Preferred embodiments of the invention will be described by way of example only and with reference to the drawings, in which:

FIG. 1: shows a schematic of the possible communications network between a node on an animal and the user or processor.

FIG. 2: shows a schematic of a portion of a farm where geo-indices are exaggerated along with their respective RSSI strength in the form of shading, with some shading having respective example RSSI values for clarity.

FIG. 3: shows a flow diagram of the system, hub, base stations, and a node.

FIG. 4: shows a flow diagram of collecting RSSI data from nodes.

FIG. 5: shows a flow diagram of transceiver selection.

FIGS. 6a, 7a, 8a and 9a: shows a schematic of a farm RSSI heat map with progressively more transceivers being turned off.

FIGS. 6 b,7b,8 b and 9 a: shows a schematic of a farm modelling radio coverage respective to Figures A of the same.

FIG. 10: shows a schematic of a farm with geo-indices defined as paddocks.

FIG. 11: shows a schematic of a farm with a paddock defined by geo-indices.

FIG. 12: shows a flow diagram of an example node.

FIG. 13: shows a flow diagram of a second example of transceiver selection.

FIG. 14: shows a flow diagram of a third example of transceiver selection, if no transceiver groups cover all nodes.

### DETAILED DESCRIPTION

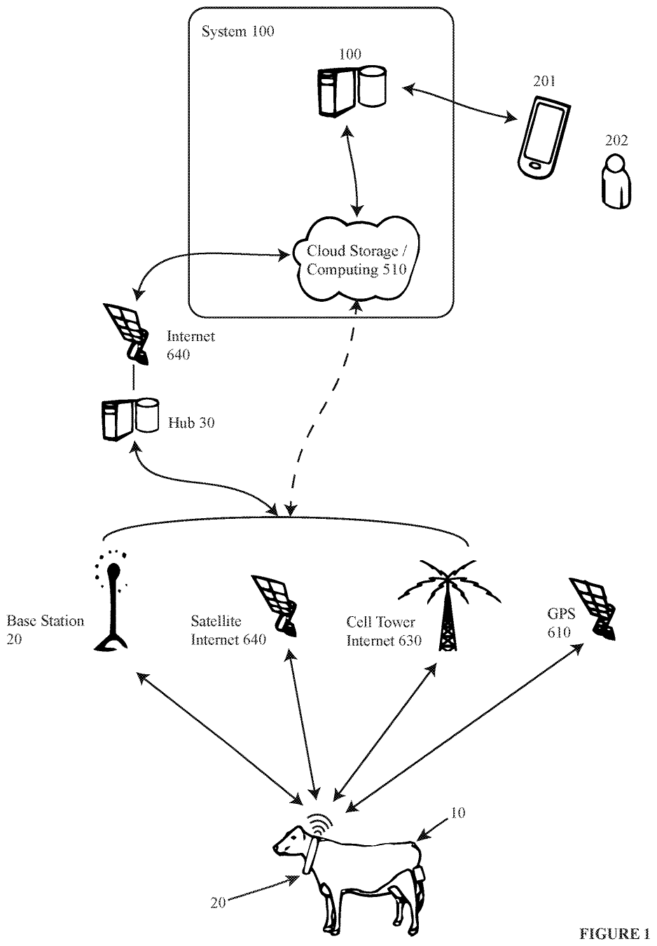

With reference to the above drawings, in which similar features are generally indicated by similar numerals, FIG. 1 illustrates a general system 1000 according to a first preferred embodiment of the invention and adapted for animal guidance.

The proposed apparatus and method can enable the selection of the best radio transmitter or transceiver 22 based on historical signal strength coverage of one or more nodes 400 which communicate with the transceiver 22. Where there are multiple transceivers 22 servicing the same area, or the same node 400, the non-selected transceiver(s) 22 can be powered down or instructed by a processor 100 to reduce power draw.

The invention can be applied in various fields, including animal tracking, smart farming, and other Internet of Things (IoT) use cases that require spanning large areas where the transceiver 22 has a limited power supply. By reducing power consumption, the proposed method can extend the battery life of these transceivers and enable more efficient use of resources.0

Overall, the present invention offers significant advantages over existing methods for reducing power usage in radio transceivers. By selecting the best transceiver based on signal strength and historical data, the system can optimise power consumption and extend battery life, making wireless communication more efficient and sustainable.

Transceivers 22 within range to receive one or more uplinks from one or more nodes 400 can be instructed to measure the link quality and/or radio signal strength (RSS), or in one embodiment, Received Signal Strength Indicator (RSSI) data, of one or more uplinks. The transceivers 22 are in one embodiment instructed to receive uplinks from all nodes 400. Or at least, all nodes 400 assigned to an area that a transceiver 22 is required to service. For example, the nodes 400 may have a farm ID, and the transceiver may also have a farm ID. If the farm IDs are the same, then the transceiver will receive the node 400 uplinks.

For the purposes of this specification, an uplink means a communication channel between two or more devices and the sending of data on that communication channel.

A node 400 can determine its location via GPS 442 and then send that information as an uplink to a transceiver 22. GPS (Global Positioning System) is a satellite-based navigation system that allows devices with GPS receivers, such as the node 400, to determine their precise location on Earth. Once the node 400 has determined its location, it can then send that information as an uplink to the transceiver 22. The node 400 is preferably instructed to send uplinks to all transceivers 22 that can listen. In one embodiment, the processor 100 has instruction the node 400 to send uplinks to all transceivers 22, and more preferably the instructions have been sent via one or more transceivers 22.

The uplink can contain the GPS coordinates of the node's location. The transceiver 22 can then forward this information to the system 1000. By combining GPS location data with the RSSI data a geo-spatial database with the associated RSSI can be populated.

Preferably the nodes 400 are carried by, or are, moving items, such as animals 10, vehicles or other assets. As these items 10 move around, the nodes 400 transmit uplinks containing data the RSSI measurements to a transceiver 22. Each time a node 400 sends an uplink, it includes geo-spatial data such as GPS coordinates, allowing the transceiver 22 to associate the RSSI data with a particular location. By collecting this data over time, a geo-spatial database can be populated with RSSI data for different locations/geo-indices 41. Each time a node 400 sends its uplink from a new location, the geo-index 41 associated with that location can be updated with the latest RSSI data.

A geo-index 41 is a way of dividing the Earth's surface into smaller, more manageable areas. The h3 geo-index 41 is a particular type of geo-index used by Uber that divides the Earth's surface into hexagonal areas of varying sizes. Each hexagonal area is assigned a unique index value, allowing data to be associated with a specific location. This indexing system allows for efficient data storage and retrieval, as well as easier spatial analysis.

The h3 geo-index 41 works by using a hierarchical indexing system, where each hexagonal area is nested within larger and larger hexagonal areas. The size of each hexagonal area is determined by the desired level of precision, with smaller hexagons providing greater precision but requiring more storage space. The index value assigned to each hexagonal area is a unique identifier that can be used to quickly and easily retrieve data associated with that location.

For example, if a node 400 sends an uplink containing GPS coordinates, those coordinates can be used to determine which hexagonal area the node 400 is in. The h3 geo-index 41 value associated with that hexagonal area can then be used to store the RSSI data collected by the node 400. Later, when analysing the data, the h3 geo-index 41 values can be used to quickly retrieve all of the RSSI data associated with a particular hexagonal area, allowing for efficient spatial analysis.

Different resolutions may be used for the geo-indices 41. The resolution of a geo-index refers to the size of the geographic area covered by each index value. A higher resolution means that the geographic area covered by each index value is smaller, allowing for more precise location data to be stored and retrieved. Depending on the use requirement, different resolutions may be used. In one embodiment, resolution 13 is used for a farming system, where the nodes 400 are on animals. In the h3 system, resolution 13 corresponds to an Average Hexagon Area (km2) of 0.000043870. It is envisaged that other resolutions are possible.

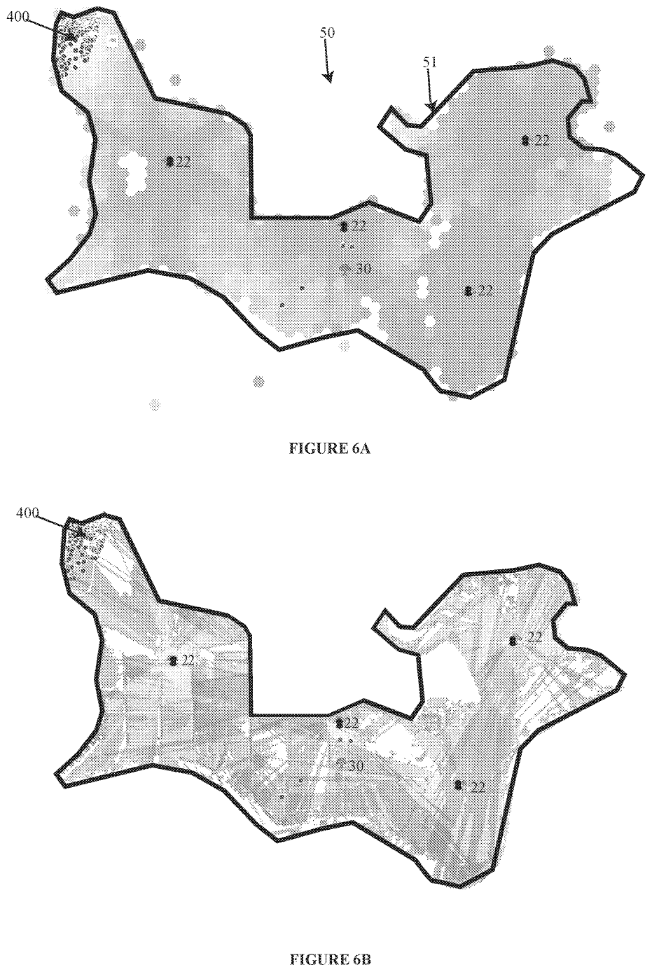

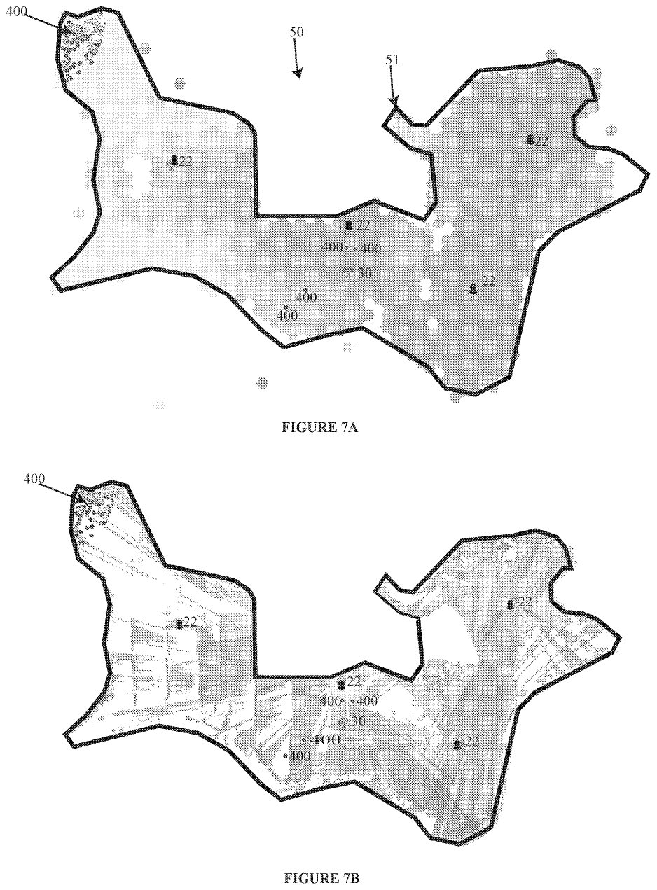

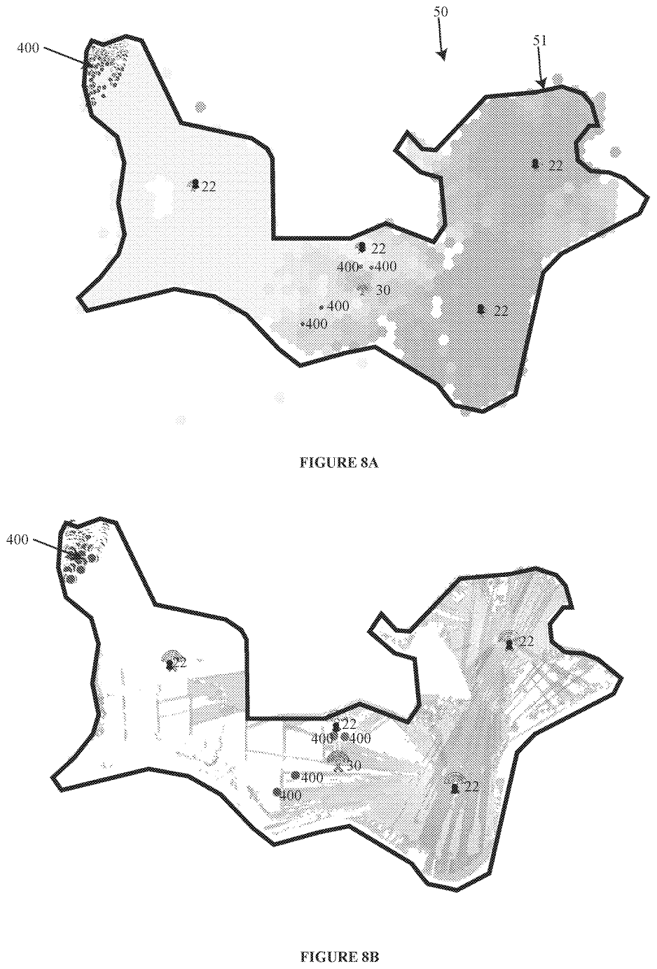

The geo-indices 41 cover the entire farm area by being distributed in a grid pattern over the area of interest as shown in FIG. 6 to 9. The size and density of the grid depend on the desired level of resolution and the area to be covered. For example, a forest may utilise a larger resolution grid, or if the terrain is very complex, a smaller resolution. For oceans, a large grid resolution may be used as the RSSI coverage will likely be very consistent.

In the context of the described system, a geo-index is a predefined geographic area that may contain data of historical RSSI from nodes 400 that have sent uplinks from the geo-index. Instead of using the h3 system to define the boundaries of a geo-index, a user-defined polygon can be used. This means that a user can draw a polygon around a specific area on a map, such as the boundary of a known paddock on a farm, or a virtually fenced paddock. The processor 100 may define that polygon as a geo-index. The paddock may be assigned a unique paddock ID.

In one embodiment, the method assigns paddock IDs to one or more geo-indices within a paddock area. The processor assigns a paddock ID to these geo-indices to create a grouping of nodes within the same paddock area. In another embodiment, the nodes that are located within the geo-indices of a paddock ID are also assigned that same paddock ID.

In one embodiment, nodes are assigned a paddock ID when they are located within a specific geo-index associated with said paddock ID. This ensures that each node is grouped into a paddock area based on its location. In another embodiment, the predefined selection criteria for selecting transceivers within a paddock area includes selecting the transceiver(s) with the highest average RSS based on the average RSS from each transceiver across all geo-indices within the same paddock ID. Alternatively, the predefined selection criteria may include selecting the transceiver(s) with the highest minimum RSS from each transceiver across all geo-indices within the same paddock ID, above a threshold RSS. This ensures that the transceiver(s) with the best link quality are selected to cover the nodes within a paddock area.

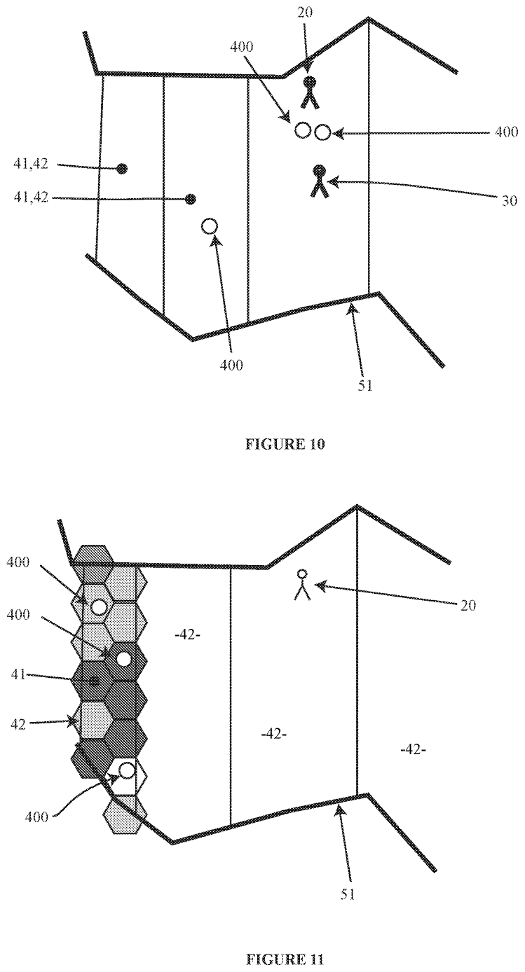

To implement a user defined geo-index, the processor 100 would need to be configured to receive and interpret the user-defined polygon data. The data could be in the form of GPS coordinates or a shapefile, which could be uploaded to the processor. The processor could then use the polygon data to define the boundaries of the geo-index. An entire farm 50 can then be geo-indexed to polygons, such as paddock shapes. An example is shown in FIGS. 10 and 11 where a portion of a farm 50, defined by outer boundaries 51, has paddocks or geo-indices 42.

Once the geo-index is defined, the processor could store the historical RSSI data as described with the h3 system. The selection criteria for the transceivers would be similar to take into account the specific polygon boundaries, such as selecting the transceiver with the highest RSSI within the defined polygon. Using user-defined polygons as geo-indices can be useful in cases where the h3 system does not accurately represent the desired boundaries or when a user wants to create a custom area for specific purposes, such as virtual fencing for animals or tracking specific crops. This system may not be as granular as the h3 system with a resolution of 13, and thus may be more prone to dead spots in coverage, as the average RSSI from a single point would be spread across the entire geo-index.

Once a geo-spatial database is populated with historical data of the RSSI respective to the transceiver 22 then the next time a node 400 is located in a geo-index 41, a processor 100 will be able to determine and select the transceiver(s) 22 most suited, based on strongest RSSI received by the transceiver 22, to service the node 400 in that geo-index.

The RSSI data is preferably collected over a time period. For example, a 30 minute time period, however other periods may also be used. If no new RSSI data is received from geo-index 41 then the RSSI data is kept. If new data is received for that geo-index within the time period, it is averaged with any other RSSI data received for that geo-index in the same time period. New averages may be taken every time period. Over time, as nodes 400, such as those worn by cows 10 on a farm 50 move around the farm 50, then RSSI data will be collected for many if not all of the geo-indices 41 that cover the farm 50 area. The farm area may be defined by a farm boundary 51. The RSSI data may be referred to as historical RSSI data, as it is received prior to the time that a current node 400 is in the geo-index. Further, the RSSI may have been populated by a different node 400 or nodes 400.

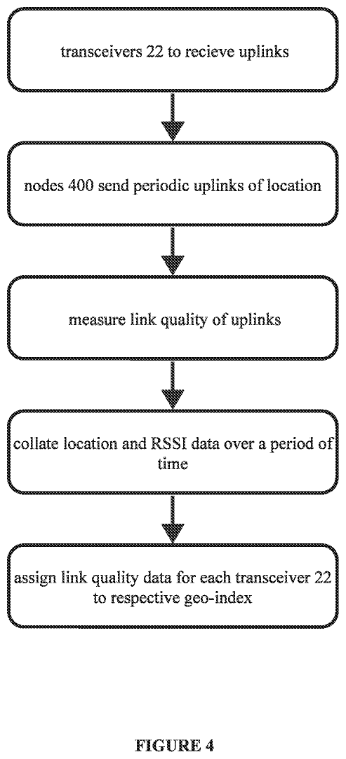

The preparation of the geo-spatial database with historical RSSI data is shown in FIG. 4.

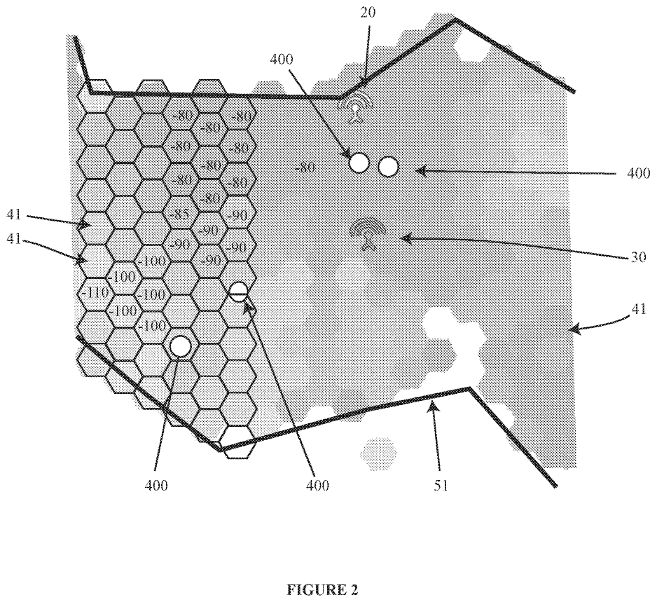

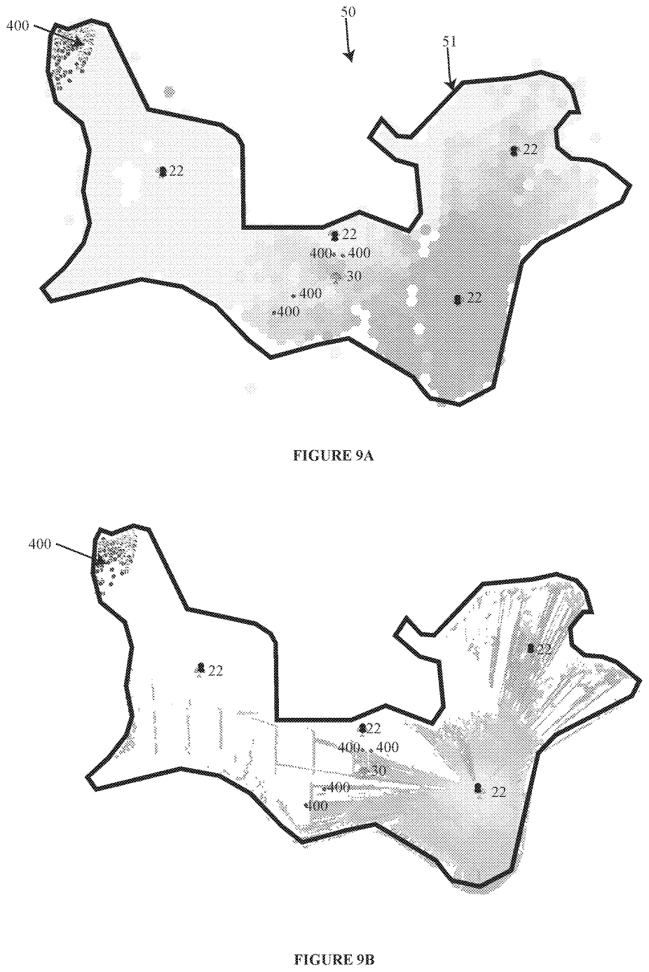

The RSSI data can be used to create heat maps or other visualisations that provide insights into the RSSI for a particular area. In this example, it is a visual representation of the RSSI data of the geo-spatial database Example heat maps are shown in FIGS. 6a, 7a, 8a, and 9a. These heat maps are a visual representation of the database 101, where the measured RSSI strength is represented by darker shades. FIGS. 6-9 shows one fewer and fewer transceivers being turned on. So FIG. 6 has all 4 transceivers on, and FIG. 9 has one. FIG. 2 shows an example of actual readings of RSSI and their associated shading. FIGS. 6b, 7b, 8b and 9b show the corresponding modelled radio coverage respective to Figures A of the same. It can be seen that the modelled radio coverage does not always correspond to the actual historical RSSI received. For example, directly above the transceiver 22 in FIG. 9b shows a dead spot in modelled radio coverage, but the same area in 9a shows relatively strong RSSI data. The present invention allows an improvement over systems where modelled coverage is relied on. FIG. 6a shows the upper left transceiver being the best transceiver, the multiple nodes 400 shown in the top left corner of the area 50. In this example, it is likely that all other 3 transceivers to the right of the area 50 could be turned off.

RSSI (Received Signal Strength Indicator) is a measurement of the power level of a radio signal received by a radio transceiver 22. It is typically expressed in units of decibels referenced to one milliwatt (dBm). A stronger signal generally indicates a higher quality link with less errors, while a weaker signal may result in more errors or even loss of the signal altogether. In the context of LoRaWAN, RSSI is used to estimate the signal strength of the LoRa radio link between the node 400 (end device) and the transceiver 22 (gateway). The RSSI value in LoRaWAN is typically expressed in negative dBm values, where a higher (less negative) value indicates a stronger signal. For example, an RSSI value of −70 dBm is considered a stronger signal than an RSSI value of −90 dBm. A weak signal is −100 to −120 dBm.

The closer the RSSI value is to zero, the stronger the signal is. For example, an RSSI of −50 dBm is better than an RSSI of −100 dBm. SNR (Signal-to-Noise Ratio) is a measurement of how much the signal stands out from the background noise. It is calculated by subtracting the noise power from the signal power and is often expressed in decibels (dB). For example, an SNR of 10 dB means that the signal power is 10 dB higher than the noise power. Both RSSI and SNR are important indicators of the radio link quality between devices and gateways in LoRaWAN networks. According to some sources, a good radio link can be considered when RSSI >−115 dBm and SNR >−7 dB. A bad radio link (range limit) can be considered when RSSI <=−120 dBm or SNR <=−13 dB. Therefore, if the RSSI is between −110 and −120 dBm, it means that the signal strength is very weak and close to the noise floor. Depending on the SNR value, the uplinks and downlinks may or may not be successful at this level. If the SNR is above −7 dB, then there is still a chance that the receiver can demodulate the signal. However, if the SNR is below −13 dB, then it is very unlikely that the receiver can demodulate the signal. When determining a threshold RSSI, the SNR could also be taken into account. Hence, the RSSI threshold may be variable.

In other embodiments, the historical data that relates to potential coverage, servicing, or adequate communication with the nodes is not measured in RSSI. One alternative measurement to RSSI is SNR (Signal-to-Noise Ratio), which is a ratio of the received signal power to the noise power. SNR provides a measure of how much the received signal is higher than the noise floor, which can be useful in environments with high levels of interference. Another alternative is RSRP (Reference Signal Received Power), which is a measurement used in LTE (Long-Term Evolution) cellular networks to measure the signal strength received by a device from the base station. RSRP is measured in dBm (decibel-milliwatts), which is a unit of power that is often used to measure radio signal strength (RSS). In addition to measuring radio signal strength (RSSI), link quality can also be evaluated by analysing the number of packets received or lost during communication. For example, a link may have a high RSSI but experience a high number of lost packets, indicating poor link quality. Conversely, a link with a low RSSI may still have good link quality if very few packets are lost during transmission.

It should be noted that the use of a broad spectrum signal can result in a low RSSI reading but still have perfectly good link quality. In contrast, a narrow spectrum signal may have a high RSSI reading but poor link quality due to interference or other factors.

Therefore, in addition or alternatively to RSSI, evaluating link quality based on packet loss and other factors can provide a more comprehensive understanding of the quality of a communication link.

In one embodiment, link quality is determined by analysing the number of packets received or lost during communication. This method involves transmitting a series of packets and counting the number of packets received successfully and the number of packets lost. The link quality is then calculated based on the ratio of received packets to total packets transmitted.

In one embodiment, link quality is determined by analysing the radio signal strength (RSS) of the received signal. This method involves measuring the strength of the received signal and comparing it to a threshold value to determine if the signal is strong enough to reliably transmit data. The RSS value is typically measured in decibels (dB) and a higher RSS value indicates a stronger signal.

In one embodiment, link quality is determined by analysing the signal-to-noise ratio (SNR) of the received signal. This method involves comparing the strength of the received signal to the level of background noise in the environment. A higher SNR value indicates a stronger signal relative to the noise and is an indication of better link quality. This method is often used in situations where there is a lot of background noise, such as in industrial or urban environments.

In one embodiment, link quality is determined by analysing the bit error rate (BER) of the received signal. This method involves transmitting a known pattern of bits and comparing the received data to the transmitted data to determine the percentage of errors in the signal. A lower BER value indicates better link quality, as it means that fewer errors are being introduced during transmission. This method is often used in situations where data integrity is critical, such as in medical or military applications.

In one embodiment, link quality is determined by analysing the delay or latency of the received signal. This method involves measuring the time it takes for a signal to be transmitted and received and comparing it to a predetermined threshold value. A lower delay or latency value indicates better link quality, as it means that data is being transmitted and received more quickly.

In one embodiment, link quality is determined by RSRP. RSRP stands for Reference Signal Received Power, which is a measurement of the power of the received reference signal in a wireless communication system, such as 4G LTE networks. It is a parameter used to evaluate the quality of the radio link between a mobile device (such as a smartphone or a modem) and a base station (such as a cell tower). RSRP is measured in decibel-milliwatts (dBm) and provides an indication of the strength of the received signal, which can be used to estimate the distance between the mobile device and the base station, among other things. In general, a higher RSRP indicates a stronger signal and a better quality of link.

Broadly speaking, link quality or radio signal strength (RSS) available to a geo-index 41 is required to aid in making a selection, or filtering and/or ranking prior to selection, of transceiver. Link quality may comprise RSS or RSSI etc. As used herein, the term RSS, or RSSI is generally interchangeable with link quality or signal strength.

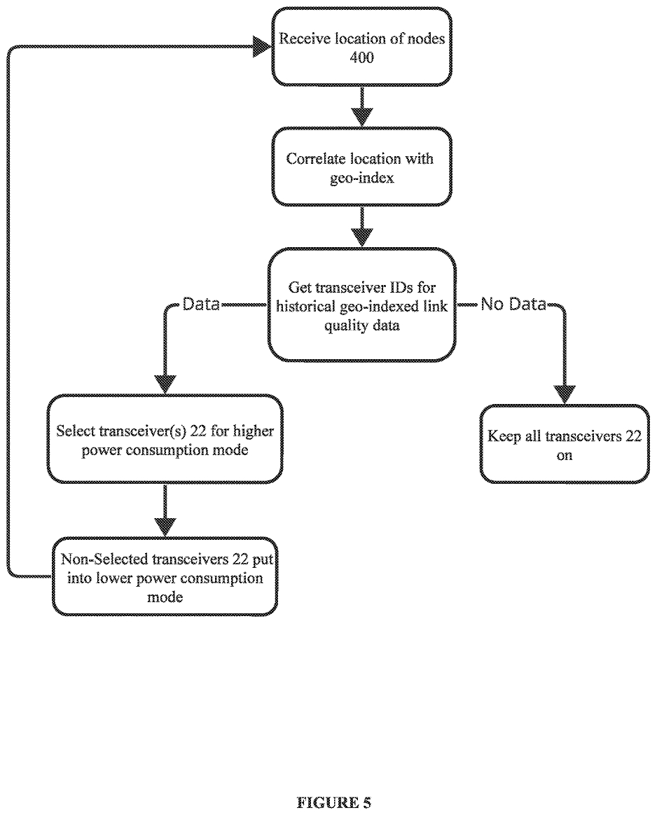

FIG. 5 shows a simplified flow chart of the processor 100 process to select the transceiver or transceivers 22 best placed to service nodes 400 in an area 50. In some embodiments there may only be one node 400 to be serviced, in which case the selection criteria is relatively simple. In such a case, first the location of node 400 is determined, much like in the process for collecting the historical RSSI data, where the node 400 uplinks its location to all transceivers 22. The node 400 location is correlated by the processor to a geo-index 41 in the geo-spatial database. The processor 100 then checks for historical RSSI data associated with said geo-index 41. If there is RSSI data then the transceiver 22 with the strongest RSSI for said geo-index is selected to communicate with the node 400. All other transceivers may then be turned off or to a reduced power operation mode.

Turning off, or reducing power to, or reducing power draw by, the transceiver is detailed below. Doing so is generally instructed by the processor 100, via a solar controller or similar. The options listed are ways the processor 100 can reduce power consumption by the non-selected transceivers in order to optimise energy efficiency. These options include:
1. Leaving off the transceiver(s): The processor simply leaves the non-selected transceiver(s) off to reduce power consumption if they are off.
2. Turning off the transceiver(s): The processor turns off the non-selected transceiver(s) to reduce power consumption if they are on.
3. Reducing power to the transceiver(s): The processor reduces power to the non-selected transceiver(s) to lower their power consumption. This may work with some hardware or gateways that can run on a lower power supply.
4. Reducing power to the transceiver(s) to zero: The processor reduces power to the non-selected transceiver(s) to zero to completely eliminate their power consumption.
5. Turning off power supply to the transceiver(s): The processor turns off the power supply to the non-selected transceiver(s) to completely eliminate their power consumption.
6. Turning off packet forwarding on the transceiver(s): The processor turns off packet forwarding on the non-selected transceiver(s) to reduce power consumption while still allowing them to remain operational.

Controlling a transceiver to be in an on or off state can be performed, for example, by interrupting a power feed to the radio hardware using a switch, such as a mosfet or similar device operable by a controller. In some embodiments, the radio transceiver hardware has a number of individual internal modules and an internal controller operable to control the operation of those modules. Accordingly, the internal controller of the transceiver may have a signal input pin which is externally controllable to signal when a high or low power mode is desired, and the transceiver operates the internal modules accordingly. One or more of the above options may be grouped to define a particular operation mode of the transceiver. The low mode is the mode that has less power consumption than the high mode. For example, a high power consumption mode may be when a transceiver is powered, and a low power consumption mode may be when the transceiver is unpowered.

In one embodiment, there are three predefined selection criteria for selecting the transceiver 22:
63 The transceiver with the highest average RSSI based on the average RSSI from each transceiver across all geo-indices which contain nodes 400. The average RSSI is calculated by taking the sum of the RSSI values from each transceiver that covers a geo-index with nodes, and dividing it by the total number of transceivers that cover that geo-index. The transceiver with the highest average RSSI is then the selected transceiver 22.
73 The highest minimum RSSI from each transceiver across all geo-indices which contain nodes 400, above a threshold RSSI. In this selection criteria, the minimum RSSI value is first calculated for each transceiver that covers a geo-index with nodes. The highest minimum RSSI value is then selected, as long as it is above a threshold RSSI value. The transceiver with the highest minimum RSSI value above the threshold is then selected as the gateway. For example, the minimum RSSI may be between a number between −100dBm to −120dBm.
83 The highest RSSI from a transceiver per geo-index which contains nodes, and the processor selects a transceiver for each geo-index. This selection criteria involves selecting the transceiver with the highest RSSI value for each geo-index that contains nodes. The processor selects one transceiver for each geo-index, based on which transceiver has the highest RSSI value for each geo-index. This method is the most power hungry, as it is likely to select multiple transceivers.

If the transceiver 22 has a battery level (SoC, voltage, run time, etc) below a certain working threshold, then the transceiver may be disregarded as a selectable transceiver 22, and the next best transceiver is selected with a better battery run time. The battery level may be determined by the processor 100 via a controller 21.

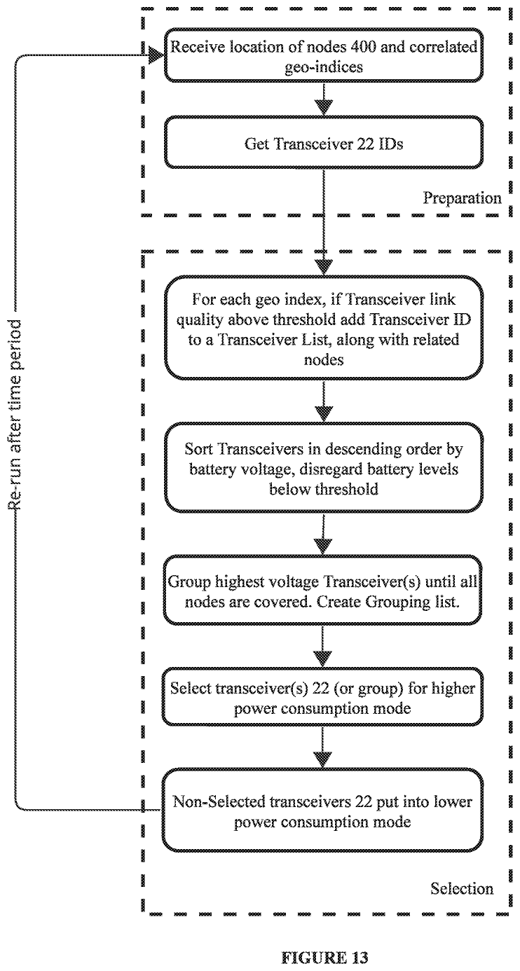

If there are multiple nodes 400 present in the area, then the process is more complex, as not all nodes 400 may be able to be serviced by one transceiver 22. in some embodiments, there may be 100s or even 1000s of nodes 400. Likewise, there may be 5, 10 to 100 transceivers. In this instance, a grouping of transceivers 22 may be selected based on a number of characteristics. For example, as shown in FIG. 13, the transceivers 22 are grouped via battery voltage available to run the transceiver.

Battery voltage can be a good proxy to estimate how long a transceiver 22 will run on a battery supply, but it is not always a reliable indicator. This is because the voltage of a battery can vary depending on the load placed on the battery, the state of charge, and the temperature.

For example, as a battery discharges, its voltage will decrease, but the rate at which it decreases can depend on the load placed on the battery. If the load on the battery is variable, such as in a device that is processing data at different intervals, the voltage of the battery may fluctuate and may not be a reliable indicator of the remaining battery life.

Therefore, to accurately estimate the remaining battery life of a device, it is important to take into account factors such as the load on the battery, the state of charge, and the temperature, in addition to the battery voltage. This can be done by measuring the current draw of the device and estimating the remaining battery life based on the current draw and the battery capacity, as well as by implementing algorithms that take into account the different factors that affect battery life. However for simplicity, the battery voltage may be described, however it may refer to battery capacity or supply. Generally, the length of time (run time) the battery will be able to power the transceiver 22 is the desired characteristic.

The selection and grouping of transceivers 22 will now be described as per FIG. 13. The process is similar to as described in FIG. 5, except now the transceivers are grouped together. The transceiver group can then be selected to service the nodes, whilst transceivers not in said group will have their power draw reduced or stopped, or power to them reduced or stopped. The transceiver may be configured to operate in multiple consumption modes. For example, a higher power consumption mode and a lower consumption power mode. A higher power consumption mode may be when the transceiver uses power, and the lower consumption power mode may be when the transceiver uses less, or does not use power. In other embodiments, however still falling into the above terminology of a power consumption mode, is if in the higher power consumption mode the transceiver is provided power, and in the lower power consumption mode the transceiver is not provided power.

To efficiently manage the power supply of the transceivers 22 in the system, grouping of transceivers 22 may be undertaken. This involves grouping some transceivers 22 to be left on to service the nodes 400 while the rest of the transceivers 22 are turned off to conserve power. The grouping process may be based on several characteristics, such as which transceivers can service all, or the majority of, the nodes or the transceivers with the most total power supply, or a combination of the two. For essential applications such as virtual fencing of animals, then all nodes must be serviced. In other embodiments it may not be necessary for all nodes to be communicating with it at all times. For example, a 50% of higher coverage rate may be acceptable. For example, if the nodes are utilising gossip or mesh networking to pass on the message to each other. In other embodiment, the service coverage may only be required to be above a threshold which is under 100% of the re-try/invocation time period to re-select is short for the selected application. For example, if the nodes move geo-indices every 5 minutes, then there is a higher chance that the nodes will be serviced in the future if the time period to re-select the transceiver is every 30 minutes.

The goal of grouping is to achieve the most efficient use of power while still providing adequate service to the nodes. The system may use algorithms to determine the best grouping of transceivers based on various criteria, such as power consumption by transceiver, node coverage, historical RSSI signal strength, and available power supply to the transceiver.

By grouping transceivers in this way, the system can ensure that the nodes are serviced by the most efficient set of transceivers, which in turn helps to extend the overall battery life of the transceivers. This is particularly important in applications where the transceivers are deployed in remote or hard-to-reach areas, where replacing batteries or recharging power supplies can be difficult or costly.

The grouping process can be used in various applications, including those where nodes are used to monitor the movement of animals in a forest or the behaviour of fish in the ocean. In each case, the transceivers may be grouped to ensure efficient coverage of the entire monitoring area while minimising power consumption.

In one embodiment, the grouping of transceivers 22 for servicing nodes 400 may involve selecting transceivers based on their battery 24 threshold power supply. The battery threshold power supply may be a predetermined level of power supply that is considered to be sufficient for servicing the nodes 400. Transceivers that do not meet the battery threshold power supply may be excluded from the grouping. This may help to ensure that the selected transceivers are capable of providing adequate service to the nodes 400, while also preserving the battery life of the transceivers. Additionally, this may help to avoid situations where the transceivers run out of power before they are able to complete their service to the nodes 400.

In one embodiment, the system selects transceivers 22 for grouping based on their battery 24 threshold power supply. Transceivers with a battery state of charge (SoC) above a certain threshold, such as 75% to 50%, are selected for grouping, while those with a lower SoC are not selected. For example, in a 28V system, a transceiver with a battery voltage of less than 25.5V may not be selected for grouping.

The calculated run time of a transceiver 22 powered by a battery 24 can be used as a threshold to determine grouping. For example, if a calculated run time for a transceiver 22 powered by a battery 24 is less than a certain threshold, that transceiver may not be selected for grouping with other transceivers to service nodes. Similarly, the calculated run time can also be used to determine if a solar-powered transceiver 22 can survive overnight or for less than a day.

In one embodiment, a method of selecting and optionally grouping where necessary the transceivers is described below.
1. Get all transceivers 22 (i.e. their IDs or serial numbers): This step involves the processor retrieving the unique identifiers for each transceiver in the area 50.
2. Get all nodes and the most recent node locations and group by geo-index: The system 1000 gathers the most recent location data for all nodes 400 and groups them based on their corresponding geo-index.
3. Determine the historical RSSI and associated transceiver 22 for each corresponding geo-index 41: The system 1000 pulls the historical RSSI for each corresponding geo-index which contains a current node 400 from the geo-spatial database. Only transceivers with an RSSI above a threshold will be associated to the corresponding geo-index 41.

In some embodiments only transceivers that have received a RSSI above a threshold will be associated with a geo-index. In other embodiments, all RSSI data is assigned to the geo-index for the associated transceiver.
4. Associate nodes 400 covered by each transceiver 22 and save to a set: For each transceiver 22, the system 1000 identifies the set of nodes 400 that it covers and stores this information.
5. Filter and rank transceivers 22 by their respective battery level: The system 1000 filters the transceivers 22 based on their battery level (SoC, Voltage, Run Time, etc) and ranks them in order of highest to lowest. This step helps to prioritise the transceivers 22 that are most likely to stay operational for a longer period of time. The step is optional, as the next step can also weight and select based on the battery level.
6. Generate transceiver grouping that will cover all nodes 22: Using the information gathered in the previous steps, the system 1000 creates grouping of transceivers 22 that covers all nodes 400. All nodes may be defined as all nodes that were identified in step 2, or all nodes that have been assigned to an area. For example, all nodes assigned a farm ID which relates to a farm area.
7. Select the best transceiver grouping based on predefined selection criteria. The groupings may be ranked by the selection criteria. The below predefined selection criteria in the below order is defined as one embodiment, however this order may be changed depending on application:
   a) Fewest transceivers 22 needed. E. g a grouping of two transceivers 22 which service all nodes 400 will be selected over a grouping of three transceivers 400 that service all nodes 200.
   b) Highest battery level (SoC, Voltage, Run Time, etc.). E.g. if the combined average battery level of a group of three transceivers 22 is higher than a combined average battery level of a group of two transceivers 22, then the higher average group will be selected, and/or
   c) Highest RSSI. E.g. if two or more groups have similar numbers of transceivers 22 and battery levels, then the group with the highest average RSSI across the relevant geo-indices 41 will be selected.
8. Add selected transceivers or group of transceivers to keep alive set: The system 1000 adds the transceivers 22 that are essential for keeping all nodes 400 in coverage or in service with a transceiver a “keep alive” set.
   a) If no suitable selection is found, keep transceivers on, or optimally, add to round robin: If the system cannot find a suitable grouping of transceivers, it either keeps all transceivers on or adds them to a round-robin process, which cycles through each transceiver in turn.
   b) For each transceiver in the keep alive set, keep alive: The system keeps the transceivers in the “keep alive” set powered on and operational.
   c) For all the other transceivers, suspend: The system suspends power to all transceivers that are not in the “keep alive” set to conserve energy.

An additional step, after step 2. would be to get all nodes currently covered by a mains powered base station 20. This is because this base station 20 has unlimited power and should be used as much as possible where it can reduce the use of limited power base stations. There may be a preferential weighting to use the mains power base station 20 over base stations 20. The mains power base station 20 is likely to also be the hub 30.

In another embodiment, where there are very large numbers of nodes, then different transceivers may be on different frequency plans. A skilled person in the art will understand that the method for grouping will need to be modified to take into account nodes assigned to transceivers on different frequency plans to ensure no nodes are left with no transceivers on, on their frequency plan. The grouping method needs modification to ensure that each node is connected to at least one active transceiver on its frequency plan.

In a broader aspect of the invention, the transceivers are not created in sets, nor groups.

The term service, in relation to servicing a node, means that the transceiver is able to communicate with the node, or at least the node is located within a geo-index which has a historical RSSI above a set threshold.

FIG. 13 shows a flow diagram of a specific embodiment of transceiver selection, where the associated transceivers that have associated nodes are first ranked by their battery level, with any transceiver with a battery level below threshold being disregarded. The transceivers are then grouped in descending order. Where a group is defined when all nodes 400 available have an associated transceiver available to them. The node has an associated transceiver with an appropriate RSSI level which services the geo-index the node is in.

In one embodiment, a controller 21 is provided to regulate power flow to the transceiver 22. In one embodiment, the controller 21 is an ethernet switch, and more preferably a power over ethernet switch. In one embodiment, the controller 21 is connected to both the batteries 24 and solar panels 25, and manages the power supply to the transceiver 22 to ensure optimal operation. In one embodiment, the controller is a solar controller. However in other embodiments the controller 21 is separate from the solar controller. The controller 21 primarily controls the power to the transceiver, and does not perform other tasks typical of a solar controller. The controller 21 may be programmable to regulate the power supply based on a number of factors, including battery voltage, current, and temperature. Additionally, the controller 21 may be remotely connected to, allowing for remote monitoring and control of the transceiver 22's power supply. This remote control capability can be especially useful in cases where the transceiver 22 is located in a hard-to-reach location or in an environment where manual adjustments may be difficult or dangerous.

By providing remote control functionality, the controller 21 reduces or stops power supply to the transceiver 22. This is one preferred embodiment of the invention. In this embodiment, the processor 100 can communicate with the controller to turn off the power to the PoE port that powers the transceiver 22. This can be useful to conserve energy when the transceiver is not selected.

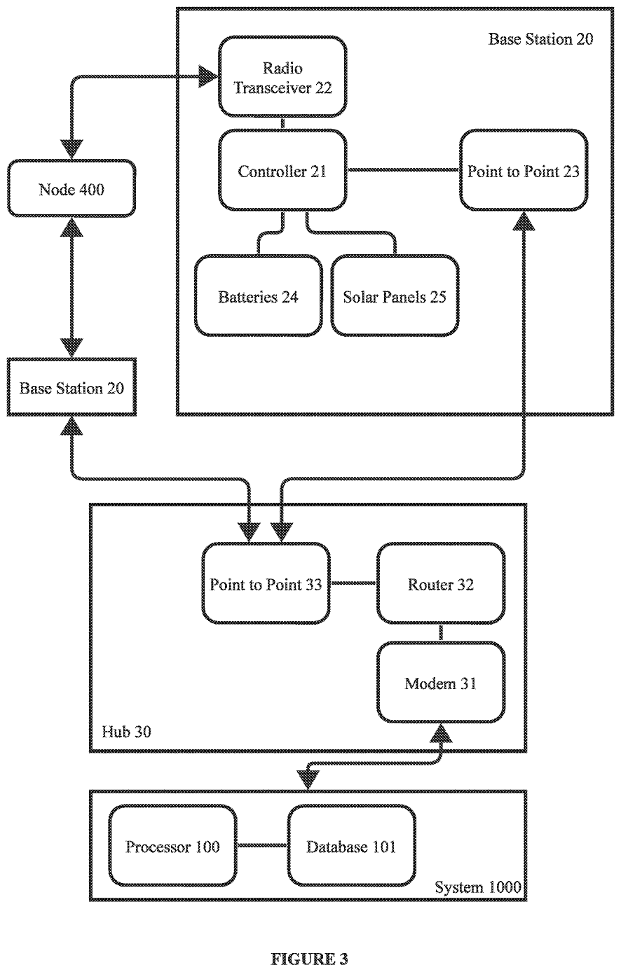

In more detail, the controller 21 is connected to the batteries 24 and solar panels 25, and is responsible for regulating the power supply to the transceiver 22. The controller 21 can be remotely accessed through an internet 640 connection. The controller 21 can indirectly connect to the internet 640 through an access point 23 (aka point to point 23), which communicates to another access point 33. The access point 33 is connected to a router 32 and modem 31, which are in turn connected to the system 1000 via an ISP or similar. An example of this system is shown in FIG. 3 where the backed system 1000 communicated with a hub 30. The hub 30 may connect to multiple base stations 20, which comprise their own transceivers 22.

The system 1000 comprises the process 100 and associated databases and storage required for the operation of the system. Through this system, the controller 21 can be remotely accessed and controlled to regulate the power supply to the transceiver 22.

The modem 31 is responsible for establishing a connection to the internet 640. Once the connection is established, the modem 31 can send and receive data to and from the processor 100, which may be cloud-based. The cloud-based processor 100 is responsible for processing the data received from the nodes 400 and the transceivers 22, and storing the processed data in associated databases and storage required. The cloud-based processor 100 can also send commands to the controller 21 via the internet 640 to adjust the power supply to the transceiver 22 as needed.

In an alternative embodiment, the processor is located on a local system at the base station 20 or hub 30 instead of being cloud-based or remote based. The local system may include a computer or server that is connected to the internet 640, but the processing is performed locally rather than on a remote server. This may provide certain advantages such as reduced latency, increased security, and more direct control over the processing and storage of data. However, it may also require more resources and maintenance to maintain the local system and ensure its proper functioning. The local system may also need to be connected to the internet 640 in order to receive updates and communicate with other systems or devices.

Multicast downlinks can be an efficient way to broadcast messages to a large number of nodes 400 simultaneously. In one embodiment multiple transceivers 22 can be configured to simultaneously send multicast messages. This is where power may be wasted as it is inefficient for more than one transceiver 22 to send the same message to the same node at one time. Hence, a selection of only the best transceiver 22 to send the message is preferred.

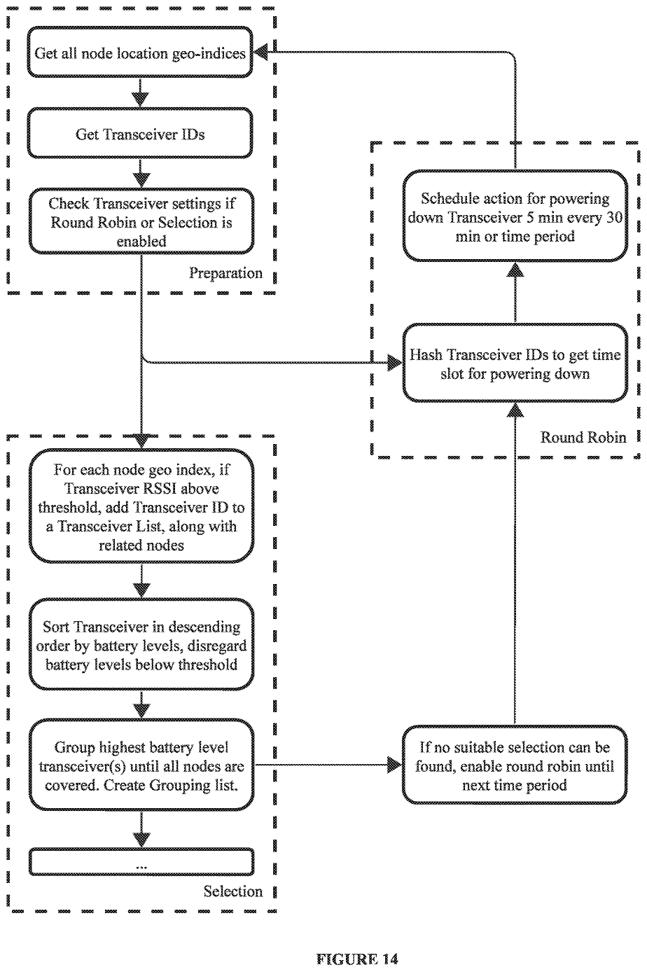

The round robin process is a method used by the processor 100 to conserve power when no suitable transceiver or transceiver grouping selection can be found, as shown in FIG. 14. The process involves the following steps:

A transceiver ID is hashed to obtain a time slot for powering down. This ensures that different transceivers are powered down at different times, reducing the overall power consumption.

The processor 100 schedules an action to suspend the transceiver 22 for a set amount of time. In this example, the transceiver 22 is suspended for 5 minutes every 30 minutes. This schedule can be adjusted to meet the specific power requirements of the system or to optimise for different factors.

The processor 100 continues to monitor the system and adjust the round robin schedule as needed. For example, if a suitable transceiver 22 or grouping is found, the round robin process may be paused or modified to ensure optimal power usage.

Overall, the round robin process provides a simple and effective way to conserve power when other power-saving methods are not available or suitable.

Here are some examples where the round robin process may occur:

If all transceivers 22 are below the threshold power, the selection process cannot choose a suitable transceiver or grouping, and the round robin process may be initiated to cycle through (turn off or on) each transceiver.

If there are no nodes 400 in the area covered by the transceivers, the selection process cannot choose a suitable transceiver or grouping, and the round robin process may be initiated to cycle through each transceiver and attempt to send multicast messages until nodes appear in the area.

If there are nodes 400 in the area but the selection process cannot find a suitable transceiver or grouping due to factors such as node movement or interference, the round robin process may be initiated to cycle through each transceiver.

The present invention utilises a node, also referred herein as device 400 configured to send and/or receive information from a radio transmitter/receiver 22. The device 400 is generally an Internet of things (IoT) device.

In one embodiment, the device 400 is configured to be worn by an animal 10. Such an animal 10 may be any of dogs, fish, birds, pets, dairy cows, beef animals, bovidae, goat, bos, bos taurus, bison, sheep, bull, lama or any other animal that is desired to be tracked, communicated with, ‘moved’, ‘shifted’, ‘drafted’, and/or ‘guided’. The invention is particularly useful to cattle that primarily feed on pasture or crops within paddocks. The animal 10 may form part of a herd of animals where one or more animals 10 in the herd wear a device 400. In this specification, the wearable device is implemented as a collar, i.e. for placement around the neck of an animal. Many placements and appropriate implementations are possible and the most suitable location will be dependent on the particular animal and environment for use. The device 400 may comprise or communicate with a secondary device 700, the device 700 optionally having some or all capabilities of the device 400.

The wearable device 400 utilises technology by the company HALTER® and is further described in patent publications WO2019180624 and WO2019180623. The HALTER® technology is capable of restraining an animal in a paddock defined by a virtual boundary, as well as being able to shift the animal from one location to another such as from a paddock to a milking shed. The wearable device 400 achieves this via administering audible signals to the left and/or right ears of the animal 10, and/or in combination with administering vibration and/or electrical stimulus to the animal 10, directionally or otherwise. The wearable device 400 utilises electronics and/or software to control stimuli using control actions, as well as to communicate externally-such as to receive target locations, transition locations etc.

The herein described device 400 functions are provided by a control system which may herein be referred to as operations of a controller. The controller is implemented by one or more computing devices which form the architecture of a system configured to perform desired functions. Reference to “controller” may refer to one or more electronic devices that are configured to directly or indirectly communicate with, or over, one or more networks. A computing device may be a mobile device. As an example, a mobile device may include a smart wearable device such as a wearable animal collar (or “collar”), a cellular phone, IoT capable device, smartphone, a portable computer, such as watches, glasses, lenses, clothing, and/or the like, and/or other like devices. In other non-limiting embodiments, the computing device may be a desktop computer or other non-mobile computer. Furthermore, the term “computer” may refer to any computing device that includes the necessary components to receive, process, and output data, and normally includes a display, a processor, a memory, an input device, and a network interface. Any or a selection of computing devices is configured to communicate with any other computing device as desired, where the terms “communication” and “communicate” may refer to the reception, receipt, transmission, transfer, provision, and/or the like of information, such as data, signals, messages, instructions, commands, and/or the like. For one controller, such as a device, a system, a component of a device or system, combinations thereof, and/or the like to be in communication with another controller means that the one controller is able to directly or indirectly receive information from and/or transmit information to the other controller. This may refer to a direct or indirect connection that is wired and/or wireless in nature. Additionally, two controllers may be in communication with each other even though the information transmitted may be modified, processed, relayed, and/or routed between the first and second controller. For example, a first controller may be in communication with a second controller even though the first unit passively receives information and does not actively transmit information to the second unit. As another example, a first controller may be in communication with a second controller and at least one intermediary controller, where a third controller is located between the first controller and the second controller, processes information received from the first controller and communicates the processed information to the second controller. In some non-limiting embodiments, data or information may refer to a network packet such as a data packet, and/or the like that includes data. It will be appreciated that numerous other arrangements are possible.

Further, in some embodiments, there is a central or master controller which may be referred to as a server, or generally as ‘the controller’. The term server or controller may refer to or include one or more processors or computing devices, storage devices, or similar computer arrangements that are operated by or facilitate communication and processing for multiple parties in a network environment, although it will be appreciated that communication may be facilitated over one or more public or private network environments and that various other arrangements are possible. Further, multiple computers such as servers or other computerised devices, directly or indirectly communicating in the network environment may constitute the controller such as a computing device configured for central service control.

Reference to “a server” or “a processor,” as used herein, may refer to a previously-recited server and/or processor that is recited as performing a previous step or function, a different server and/or processor, and/or a combination of servers and/or processors, and refer to general implementations of processors which form the functional elements of the controller. For example, a first server and/or a first processor that is recited as performing a first step or function may refer to the same or different server and/or a processor recited as performing a second step or function. Further, reference to a server or processor may refer to a group of servers or group of processors, each configured to perform a task. Such tasks may include processes or algorithms which are undertaken by one or more servers of processors. Tasks undertaken by any one or more processors, such as by an on-collar and/or off-collar processor, are therefore to be understood as tasks undertaken collectively by the controller or control system.

Embodiments of this disclosure include reference to cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Some embodiments are private clouds where the cloud infrastructure is operated solely for an organisation. Other embodiments are community clouds, where cloud infrastructure is shared by several organisations and supports a specific community that has shared concerns such as security requirements, policy, or compliance considerations. The community cloud may be managed by the organisations or a third party and may exist on-premises or off-premises. In some embodiments, a public cloud infrastructure is made available to the general public or a large industry group and is owned by an organisation selling cloud services. A cloud computing environment is service-oriented with a focus on statelessness, low coupling, modularity, and semantic interoperability. At the heart of cloud computing is an infrastructure comprising a network of interconnected nodes. The cloud computing models may be managed by the organisation or a third party and may exist on-premises or off-premises. One applicable implementation model for the present disclosure is by Software as a Service (Saas). SaaS is the capability provided to the consumer to use the provider's applications running on a cloud infrastructure.

The applications are accessible from various client devices through a client interface such as a web browser. The consumer does not typically manage or control the underlying cloud infrastructure including network, servers, operating systems, storage, or even individual application capabilities.

In some embodiments described herein, the wearable device comprises a controller configured to operate functions of the wearable device, and the wearable device communicates with a computing device operating as a controller configured to manage control of the wearable device. The animal guidance system has a wearable device (collar) adapted to be worn by an animal as will be discussed in further detail below. However, the wearable device has at least one stimulus device operable to administer at least one form of stimulus to the animal and guide the animal to the target.

The animal guidance system further has at least one positioning system configured to output animal position data. The guidance system may be provided by a GPS device 442 located on the wearable device, or local positioning system. Many forms of the positioning system are possible, and some of which are discussed in further detail below.

The animal guidance system further has at least one animal activity sensing device configured to output animal activity data. Animal activity data typically includes data relating to the movement of an animal as defined by one or more sensors configured to generate a signal based on a change on any one or more degrees of freedom as may be desired. Further detail on animal activity data and interpretation of said data to indicate animal activity is discussed below.

The animal guidance system further has at least one controller module configured to undertake particular functional requirements. The specification below will discuss many functions in terms of desired outcomes, data and considerations to support those outcomes. It should be understood that for each outcome, the controller is configured to receive information, undertake any one or more functional steps based on the received information, and generate an output operable to achieve the stated outcome. For example, in some embodiments, the controller is configured to receive the animal position data, receive the animal activity data, determine animal behaviour information from the animal position data and/or animal activity data, and generate an output operable to control at least one stimulus device to administer the stimulus to guide the animal to a target location.

In some embodiments, the controller is made up of several discrete processing devices, such as microprocessors or other equivalent forms of computing device, and collectively form a control system. Further, those processing devices are distributed over a variety of locations, and may be interconnected as a network. The processing devices of the network are connected, preferably wirelessly. A wearable animal apparatus may for example have a processor configured to receive and act on data from the animal positioning system and animal activity device. That data may be communicated via the network to one or more other processing devices.

In some embodiments, one of the processing devices acts as a master device that connects to any number of other devices, collates data from any one of the number of other devices, makes decisions based on that collated data, then communicates instructions to any one or more of the other processing devices. For example, in some embodiments, the controller has at least one master processing device connected to a number of other processing devices which are located on an animal wearable collar. In such embodiments, the master processing device acts as a first controller module part and the one or more on-collar processing devices acts as a second controller module part, the controller module parts acting together as the controller of the control system. In some embodiments, the controller of each wearable device has control status data which defines where on a hierarchy of apparatus that particular apparatus is ordered. In exemplary embodiments, that status data includes data which defines the apparatus as a master, for determining and sending control decisions, and a slave, for receiving and acting on those control decisions.

In some embodiments, functions of the controller are enabled according to a SaaS subscription status. In order for the animal to move to a target location, a controller configured to operate the wearable device (also herein called a collar) must determine or be supplied with the target location. As such, the controller must determine at least the animal location and a target location, and any other used variables to output to the stimulus device a stimulus or stimuli to suggest movement to the animal to the target location.

In the preferred embodiment, the controller onboard the wearable device is configured to receive a signal from an off-collar (off-wearable device) location relating to the target location. In some embodiments, the target location comprises a destination at the end of a pathway or heading. In some embodiments, the path between the target location contains one or more waypoints where the animal is desired to either pass through or exhibit some kind of behaviour when nearby. In further embodiments, the controller onboard the wearable device is configured to receive a signal from an off-collar (off-wearable device) location relating to the paddock or area that is to virtually restrain the animal within. The off-collar processor may be located in the cloud, on a remote PC, or on a user's computing device etc.

In other embodiments, the wearable device comprises the processor. In further embodiments, determination of the above information to be determined is on the processor of the wearable device, or on both the off-collar and on-collar processors. Within this specification, where calculations or determinations are required, it is assumed they are performed by the control system which comprises computation by an on-collar processor and/or an off-collar processor. For example, in some exemplary embodiments, activity and location information is determined by the on-collar processor, whereas the target location and stimulus controls may be determined by an off-collar processor. Other implementations are possible. FIG. 1 is one example of a general communication system infrastructure diagram incorporating the features of the invention in an example where a node 400 in a field is being monitored and optionally controlled. In this specification, geographical control of sensors or animals is performed with a node 400 or wearable device 400. In one embodiment, the wearable device 400 further operates to output stimuli that operate to guide an animal. Guidance of an animal is conducted with animal guidance information, and such information may include geographical boundary information, geographical target information and control operations, including stimuli output, which elicit movement of an animal to the target location, and many other animal guidance controls.

In this relatively simple example, a user 202 tracks the position of a cow 10 within a particular portion of the field and if deemed necessary or desirable, outputs guidance information which may cause the application of a desired form of stimulus to the cow to thereby elicit a response from the animal, such as guiding the animal to a new location.

The user 202 may use a software application (such as a mobile app) on mobile device 201 or PC 202, which includes, or can receive data from the internet. This software application, as well as any processors or server utilities in communication with the mobile device or PC, may be referred to as the “backend”. Again, the backend may be anything that communicates with the gateway, that is not on the collar side of the gateway. However, in most applications, the backend represents a computing device that is immobile. The server and/or the PC 100 and/or the person's 201 user device 202 may, in some embodiments, be referred to as a first or primary transmission device operating a first transmission protocol to communicate with the wearable device 400.

The wearable device 400 can send and receive data from local wireless data transmission devices 20 (embodied as a tower or base station). The base stations 20 are configured to send and receive wireless communications, and in some cases, function as a transceiver 22. The base stations 20 can send and receive information to cell towers or satellites to the internet to store data stored on a remote server, such as cloud server 510—i. e a backend. One preferred form of a base station 20 is a spread spectrum low-frequency RF transmitter. For example, as part of a LoRa transmission protocol system as will be explained with reference to a preferred embodiment below.

The wearable device 400 is capable of detecting signals originating from one or more of GPS satellites 840, gateways 22 of the first communication protocol, short-range communications devices as discussed further below, and one or more cell towers 630, user devices 201 including short-range communication signals such as Bluetooth.

By connecting with the Internet 640 via WiFi, Bluetooth, or cellular transmissions such as 3G,4G, LTE and others, the software application may access the data stored on the remote server, such as cloud server 510. The data contained in the cloud server 510 can also be accessed by a processor of a computing device, such as a PC 100, via a connection through the Internet 640.

The PC 100 or a user device (such as mobile device 201) comprises a user interface and/or server, and for some embodiments, is configured to perform the control action on the basis of a control command. Preferably, the processors of the control system are operatively connected to or are part of a user device such as a smartphone, PDA, PC, laptop or any other suitable user device.

The user 202 may monitor the result of the comparison performed by a processor that is either part of, or is operatively connected to the collar 400, on a screen of the mobile device 830, and depending upon the result of the comparison, the user 202 may send an appropriate control command including animal guidance information. The control command may then be received by the collar collar processor 470 which will then determine, according to the control command received, whether a control action is required.

Preferred embodiments include a position sensing system, or interface with a position sensing system that acts to locate nodes 400 and locations of interest within a consistent geographical frame of reference. The position sensing system 442 operates to node 400 position data. The position sensing system further operates to provide a reference to any one or more locations. The position sensing system further operates to provide a relative frame of reference to the node position data and the one or more locations. In one embodiment, the node 400 is a collar 400, and the position data is related to an animal. However the position data may relate to other animals, vehicles, people, industrial equipment or other sensors.

In preferred embodiments, the controller is configured to receive or determine location information as described above, including the one or more locations of interest. The location information may be in the form of coordinate data. In some embodiments, the position sensing system is a local positioning system (LPS) or GPS. Each of the local or global positioning systems include one or more transmitter components that output location reference data, and a receiver component that receives the location reference data and determines a location of the receiver component relative to the reference data. For example, LPS transmitters may include one or more beacons such as cellular base stations, Wi-Fi access points, and radio broadcast towers to compute the position of the receiver/sensor.

Locating position information of an object with a GPS position sensor is previously known in the art and calculation of a position is performed by precisely timing the signals sent by GPS satellites high above the Earth. Each satellite may continually transmit messages that may include the time the message was transmitted, precise orbital information (the ephemeris), the general system health, and rough orbits of all GPS satellites (the almanac). The GPS sensor/receiver may use the messages it receives to determine the transit time of each message and compute the distance to each satellite. These distances along with the satellite locations may be used with the possible aid of trilateration, depending on which algorithm is used, to compute the position of the receiver/sensor, and therefore the animal attached to the receiver/sensor.

In preferred embodiments, position data is derived from a positioning system receiver attached to a collar worn by an animal and is configured to communicate LPS or GPS data to the controller to thereby indicate the animal position data.

In some embodiments, the controller is configured to determine the location of node 400. In such embodiments, the controller is configured to receive position data from a position sensing receiver located on each node 400. For many nodes 400, the controller may thereby determine the location of each node 400 which includes a position sensing receiver. In some embodiments, the controller is configured to receive position data pertaining to one or more locations of interest within the geographical frame of reference. In some embodiments, the controller is configured to determine if a control action is required based on a comparison of at least one received position with other position data. The position data may include longitude, latitude, altitude, and/or horizontal position or coordinate data pertaining to the node 400 or other locations of interest.

FIG. 2 is an exemplary depiction of a wearable device (collar) 400 worn by a cow 10. The collar 400 is a housing for numerous electronic components which perform or assist operation functions. The exemplary collar 400 has a positioning system such as a GPS unit; multiple wireless network communication radios operable to communicate on multiple radio frequencies according to multiple communication protocols; any number of animal movement sensors such as an IMU/accelerometer, gyroscope, compass or similar; and a collar processor 470.

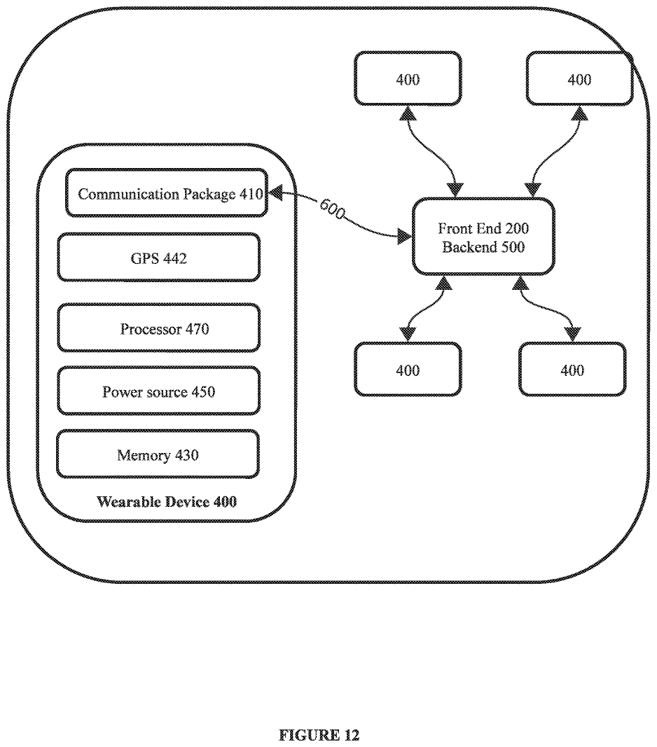

FIG. 12 shows a schematic diagram of particular (but not exclusive) electronics devices of the wearable device 400 which are functionally required by some embodiments discussed herein. The particular components may comprise the above-mentioned collar processor 470; one or more communications device 410; and a memory component 430 which is operable to store data such as the aforementioned virtual boundary or and device status data, such as stored location, instructions to send uplinks, virtual fence boundaries, and instructions to receive downlinks etc. One or more stimulus devices are typically included on the collar for enabling animal guidance controls. Stimulus devices include shock deployment electronics, light sounds and vibration output devices. A GPS 442 and one or more movement sensors are typically included for the determination of location and movement. Movement sensors may include devices such as inertial measurement components, accelerometers, gyros, magnetometers, and environmental sensors such as moisture, temperature and humidity sensors. The collar processor 470 is connected to and configured for the control of the other components of the collar.

The node 400 comprises one or more antennae that operate to communicate radio signals from the communications device 410 to and from the collar. A GPS antenna may also be integrated with the antennae of any one or more of the communications devices. For example, the antennae may comprise separate elements tuned for particular radio communication frequencies, or may have broadband or multiband elements such as combining GPS receiver with wireless network communication into a single package, and or for short-range communications.

In some embodiments, movement data is derived from the GPS signal. For example, a heading and speed can be derived from changing GPS coordinates; or acceleration data can be derived from changing GPS coordinates and thereby used to determine a change in speed and displacement. In some embodiments, the device 400 contains an IMU configured to directly sense, for example, movement and heading data. Any number of IMU sensors may also be contained on the device 400 for providing animal guidance data. Any combination of GPS and IMU-derived position and location data may be used by the controller as part of the deployment of guidance data or determinations of guidance data.

Power for the electronic devices of the device 400 is provided by a battery 450, preferably rechargeable. The battery is typically supported by a charging circuit and renewable energy source such as a solar panel. Particular operations to mitigate power consumption are discussed further below. Preferably the battery is rechargeable. Preferably the recharging power is provided by a solar or wireless power transfer device. However, in some embodiments, the battery is intended to be recharged by removal of the collar from the animal and connected to a source of charging power.

The limited power available from the battery makes power consumption an important consideration for the operation of collar functions. Particularly high current consumption devices include the first communications device 410 and a second communications device 420 which are typically radio transceiver devices. Management of transceiver operation, including using the most preferable transceiver at any one time, such that power is not consumed by both devices substantially simultaneously, is particularly important for minimising power consumption.

In preferred forms, the first communications device 410 is a radio transceiver or uses a radio signal in order to report the status of the node (status data) and/or to update a new area boundary, receive new instructions, receive commands, and/or other parameters such as the communication of other sensor data.

The first communications device 410 is configured to communicate to at least the radio transceiver 22. One communication protocol of the first communications device 410 is a LoRa protocol. However, it is envisaged other long-range communication protocols may be used, such as LPWAN, WiFi, WiMAX, SigFox, LTE-M, DASH 7, IEEE 802.11ah, CC 430, NB-IoT etc.

In one embodiment, LoRa (from “long-range”) is the physical proprietary radio modulation technique used for communication between a locally situated communications tower 860 and the devices 400. LoRa is based on spread-spectrum modulation techniques derived from chirp spread spectrum (CSS) technology. LoRa was developed by Cycleo (patent U.S. Pat. No. 9,647,718) and later acquired by Semtech.

LoRaWAN defines the software communication protocol and system architecture. LoRaWAN is a media access control (MAC) protocol for wide area networks. It is designed to allow low-powered devices to communicate with Internet-connected applications over long-range wireless connections. The continued development of the LoRaWAN protocol is managed by the open, non-profit LoRa Alliance, of which SemTech is a founding member.

The LoRaWAN network uses a centralised entity, called a gateway 22 or transceiver 22. LoRaWAN is based on a single-hop star topology. Where the gateway 22 sends information packets to one or more nodes. In one example of this, the nodes are smart wearable devices carried by animals.

Internet of Things use cases, such as, smart cities, smart farms, agriculture, forestry, wildlife tracking etc often require spanning large areas. Sometimes tens, to hundreds, to thousands, of sensor nodes are deployed to support such use cases.

Typically, an IoT use case comprises severely resource-constrained devices—such as the device 400.

Whereas the device 400 is constrained by power constraints, as it relies on solar power and a lightweight battery. Due to the power constraints, other established long-range technologies are not usable. LoRa offers long coverage, and reliability and can be used at very low power.

LoRaWAN is built as a star-of-stars topology, where the devices located in the defined area are able to send packets (data, information) to a gateway 22 which is then responsible for forwarding those packages to the backend.

A front-end module (FEM) can be utilised between the transceiver of the long-range communications device and antenna to efficiently optimise both the transmission range and receiver sensitivity. A FEM integrates transmit power amplification, receive low noise amplification, antenna switching between the transmit and receive paths, and the required matching and filtering.

In one embodiment, the device 400 comprises a 860 to 930 MHz RF Front-End Module from Skyworks. In particular, the device 400 comprises a SKY66420-11. The SKY66420-11 is a high-performance, highly integrated RF front-end module designed for LPWAN—supporting LoRa®, SigFox and other unlicensed band technologies.

For the purposes of illustrating embodiments, the first communications device 410 is to be considered “long range”, meaning that the usable range of wireless communications is further than that of the second communications device.

In preferred forms, the node 400 comprises a second communications device for example, a radio transceiver or uses a radio signal in order to report the status of the apparatus (status data) and/or collar and/or to update a new area boundary, receive new instructions, receive commands, and/or other parameters such as the communication of guidance data.

The second communications device has short-range communication capabilities. Short-range communication capabilities include one or more of the following protocols, Bluetooth®, Bluetooth Low Energy, Near-field communication (NFC), Wi-Fi, Infrared, Ultra-Wideband and Zig-Bee.

The first and second radio transceivers are optimised for long and short-range communication respectively. Accordingly, it is preferable that the first transceiver communicates with a device located at a relatively long range, while it is also preferable that the second transceiver communicates with a device that is located at a relatively short range. Either first or second communications devices may be used independently or in combination.

The radio signal in one embodiment from the transceiver is based on LoRa protocol. However, it is envisaged other long-range communication protocols may be used, such as LPWAN, WiFi, WiMAX, SigFox, LTE-M, DASH 7, IEEE 802.11ah, CC 430, NB-IoT etc.

In some embodiments, the transceiver 22, also known as a gateway 22, is a Kona Macro IoT Gateway from Tektelic Communications. The Kona Macro IoT Gateway is targeted at network sites that dictate a small form factor, however it has a relatively large power consumption.

Rak Wireless is a company that produces various types of transceivers for IoT applications. Their transceivers are designed to be low-power, low-cost, and reliable, making them ideal for a wide range of IoT applications. Some of the popular transceivers produced by Rak Wireless include the RAK811, RAK4200, and RAK4600. These also be used as the transceiver 22. Rak Wireless gateways generally use lower power then the Kona Macro.

The gateway 22 can communicate with the node(s) 400 as well as the backend 500 and processor 100. The power consumption of the Kona Macro IoT Gateway from Tektelic Communications can vary depending on the mode of operation and usage scenario. Selecting transceivers 22 to be turned on, whilst the others are left off allows the battery SoC to increase whilst the transceiver 22 is off, allowing a longer run time, and less downtime during periods of low sunlight, for example in winter, and at night. The invention can be used in many industries where there are radio transceivers that are solar powered or have limited battery life, and the nodes often move around. For example, it can be used in agriculture to track the movements of animals and to guide them to specific locations within a field. It can also be used in forestry to track the movements of wildlife or monitor forest fires. In addition, it can be used in logistics to track the location of goods or vehicles as they move through the supply chain. Further, the nodes could be attached to a hiker's backpack, or be within an IPERB, and use GPS to track their location and communicate with rescue teams in the event of an emergency. Similarly, the device could be attached to birds or sea creatures to track their movements and gather research data where the radio transceivers are often in remote locations, such as in mountains, or on buoys, and require power to be saved. Nodes may comprise asset tracking devices, wearables, smartphones, drones, smart vehicles, or environmental sensors.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A method of operating a processor to remotely control the power use of two or more fixed location radio transceivers, the control being dependent on the location of one or more movable nodes located in an area, the method comprising:
populating a geo-spatial database with link quality data associated with the one or more historical nodes as received by each transceiver over a period of time, by the steps of:
a. instructing all transceivers to receive one or more uplinks from the one or more historical nodes, the uplinks comprising at least historical node location data;
b. instructing the one or more historical nodes to send periodic uplinks;
c. measuring link quality of one or more uplinks;
d. associating each node location with a geo-index of the geo-spatial database; and
e. assigning the link quality data and associated transceiver to said geo-index; and
receiving an uplink from nodes and determining their current location from said uplink and their associated geo-index, the nodes being the same or different to the historical nodes whose link quality was measured;
identifying associated transceivers with link quality data above a threshold for each associated geo-index;
determining a selection of the one or more said identified associated transceivers based on one or more predefined selection criteria; and
reducing power to, or consumption of power by, all other transceivers except the one or more selected transceivers.

2. The method as claimed in claim 1, wherein the link quality data is defined by analysing or determining one or more selected from
number of packets received or lost during uplink;
signal-to-noise ratio of the uplink;
bit error rate of the uplink;
received signal strength indicator of the uplink;
delay or latency of the uplink;
carrier-to-noise ratio of the uplink;
modulation and coding scheme used for the transmission of the uplink;
presence of interference of the uplink from other nearby wireless devices or sources;
received signal strength of the uplink; and
reference signal received power of the uplink.

3. The method as claimed in claim 1, wherein the method comprises creating a set relating to an associated transceiver and including the associated nodes the transceiver receives an uplink from.

4. The method as claimed in claim 3, wherein the method comprises grouping together transceiver sets, where each group is a different combination of transceivers.

5. The method as claimed in claim 1, wherein the predefined selection criteria comprises one or more of the following:
the most or all nodes of the associated geo-indices, or the group with the fewest transceivers which comprises all nodes,
a highest battery level of the transceiver, or a highest average battery level of a group of transceivers, and
the highest link quality for a geo-index, or the highest average link quality over multiple geo-indices, or the highest average link quality over a group of transceivers.

6. The method as claimed in claim 1, the method comprising the step of: determining a ranking of at least two transceivers based on the selection criteria, and where: the highest average, highest minimum, or highest, link quality data is within a predefined threshold, and the lower ranked of the ranked transceivers has higher available battery level, selecting the lower ranked transceiver.

7. The method as claimed in claim 1, wherein the predefined selection criteria comprises one of:
the highest average link quality, where the average link quality is across all geo-indices which contain nodes,
the highest minimum link quality across all geo-indices which contain nodes, above a threshold link quality,
above a threshold link quality across all geo-indices which contain nodes, and
the highest link quality from a transceiver per geo-index which contains nodes and the processor selects a transceiver for each geo-index.

8. The method as claimed in claim 1, wherein reducing power to, or consumption by, the non-selected transceiver(s) comprises one of more of:
leaving off the transceiver(s),
turning off the transceiver(s),
reducing power to the transceiver(s),
reducing power to the transceiver(s) to zero,
turning off a power supply to the transceiver(s), and
turning off packet forwarding on the transceiver(s).

9. (canceled)

10. The method as claimed in claim 1, wherein the transceiver is a long-range radio gateway.

11. (canceled)

12. The method as claimed in claim 1, wherein the transceiver is powered by a limited or finite power supply.

13.-17. (canceled)

18. (canceled) The method as claimed in claim 1, wherein one or more geo-indices within a paddock area are assigned a paddock ID by the processor.

19. (canceled)

20. The method as claimed in claim 1, wherein the predefined selection criteria comprise one of:
the transceiver(s) with the highest average link quality based on the average link quality from each transceiver across all geo-indices with the same paddock ID,
the highest minimum link quality from each transceiver(s) across all geo-indices with the same paddock ID, above a threshold link quality.

21.-29. (canceled)

30. A system for controlling power usage of radio devices comprising:
one or more moveable nodes, each node comprising:
a sensor configured to determine location data, and
a transmitter configured to transmit location data by radio uplinks;
two or more fixed location radio transceiver devices, each device comprising a radio component configured to receive uplinks and output transceiver data comprising link quality data and node location data; and
a processor configured to:
receive transceiver data,
populate a geo-spatial database with received transceiver data including geo-indices of transceiver data based on the node location data, and
control one of two or more power consumption modes of one or more radio transceiver devices based on:
node location data,
a determined geo-index, and
one or more predefined selection criteria.

31. The system as claimed in claim 30, wherein the link quality data is defined by analysing or determining one or more selected from
number of packets received or lost during uplink;
signal-to-noise ratio of the uplink;
bit error rate of the uplink;
received signal strength indicator of the uplink;
delay or latency of the uplink;
carrier-to-noise ratio of the uplink;
modulation and coding scheme used for the transmission of the uplink;
presence of interference of the uplink from other nearby wireless devices or sources;
received signal strength of the uplink; and
reference signal received power of the uplink.

32. (canceled)

33. The system as claimed in claim 30, wherein the processor is configured to create a set for an associated transceiver and the associated nodes the transceiver receives an uplink from.

34. The system as claimed in claim 30, wherein the processor is configured for grouping together transceiver sets, so a majority of nodes are assigned at least one transceiver within a group.

35. The system as claimed in claim 30, wherein the processor is configured for grouping together transceiver sets, where each group is a different combination of transceivers.

36. The system as claimed in claim 30, wherein the processor is configured for determining a ranking of at least two transceivers based on the selection criteria, and where: the highest average, highest minimum, or highest received signal strength data is within a predefined threshold, and the lower ranked of the ranked transceivers has higher available battery level, selecting the lower ranked transceiver.

37. The system as claimed in claim 30, wherein the processor is configured for reducing power to, or consumption by, the non-selected transceiver(s) comprises one of more of:
leaving off the transceiver(s),
turning off the transceiver(s),
reducing power to the transceiver(s),
reducing power to the transceiver(s) to zero,
turning off a power supply to the transceiver(s), and
turning off packet forwarding on the transceiver(s).

38.-40. (canceled)

41. The system as claimed in claim 37, wherein the power supply comprises a solar power supply and batteries.

42.-48. (canceled)
